(19) United States
(12) Patent Application Publication
(10) Pub. No.: US 2017/0329908 A1
(43) Pub. Date: Nov. 16, 2017

(54) Automated Healthcare Scheduler System and Method

(71) Applicant: Schedule APP, LLC, Winter Park, FL (US)

(72) Inventor: Anthony Braswell, Tampa, FL (US)

(73) Assignee: Schedule APP, LLC

(21) Appl. No.: 15/446,113

(22) Filed: Mar. 1, 2017

Related U.S. Application Data
(60) Provisional application No. 62/335,975, filed on May 13, 2016.

(51) Int. Cl. G06F 19/00; G06Q 10/10; G06Q 40/00

(52) U.S. Cl. CPC G06F 19/327; G06Q 40/125; G06Q 10/1093

(57) ABSTRACT

The scheduler matches staffing requirements with qualified healthcare workers, each having a GPS cell phone. The workers have an online UPP and a calendar with OPEN/CLOSED shift dates/times. Once matched to a staffing requirement, workers are notified and within 15 minutes they must respond. Non-responses reduce the selection ranking of workers. For shift-assigned workers, the system gathers worker GPS data prior to the shift-time. Transit time or distance is monitored from the worker geolocation to the facility. If dynamic thresholds are exceeded, alerts are generated to the worker and the manager. The facility sends a cancel, hold open or replace command for the shift. If replace, the system repeats a worker identify, match, notify, accepting response, prioritize, and notify selected worker for the shift.

This is a regular patent application based upon and claiming the benefit of provisional patent application Ser. No. 62/335975, filed May 13, 2016, now pending, the contents of which are incorporated herein by reference thereto.

The present invention relates to an automated healthcare scheduler system and method which automates and coordinates temporary staffing by registered nurses (RN) and other licensed healthcare workers (HC-W) with healthcare facilities (HC-Fac) that need and have staffing requirements. Sometimes registered nurses RN are referred to as being healthcare workers HC-W and, at other times, healthcare workers are referred to as RN. Therefore, these temporary staff workers are sometimes generically referred to as RN.

### BACKGROUND

Although there are mobile work force systems and methods, the need in the healthcare system is more acute due to the need to fill hundreds of healthcare worker staffing positions each day, and those staffing requirement vary greatly day-today due to the ebb and flow of patients through hospitals, nursing homes and related healthcare facilities. Oftentimes highly qualified RNs and healthcare workers are needed in surgical suites on an as-needed basis. This need for highly skilled persons to fill, on an as-needed basis, temporary medical staffing positions is greatly effected by traffic delays, unforeseen breakdowns of transportation (car and bus breakdowns), and adverse personal events. Under such conditions, the healthcare facility needs know about in-transit delays and establish a system that can quickly replace the missing healthcare worker.

### Objects of the invention

It is an object of the present invention to provide a system for motivating registered nurses and licensed healthcare workers (RN/HC-W) to select staffing requirements or staffing needs which are available via the automated scheduler system.

It is another object of the present invention to provide automated assurances that the healthcare worker or selected staffer or RN/HC-W arrives at the healthcare facility on time for the staffing event (that is, the HC-Fac shift).

Is a further object of the present invention to match, on an as-needed basis, licensed RN/HC-W staffers with staffing requirements from a plurality of healthcare facilities.

It is an additional object of the present invention to provide the healthcare facility with prior notice of a healthcare worker not being able to clock in at the predetermined time or shift in a predetermined medical unit and, in the event that the healthcare worker cannot meet that temporary employment obligation, the manager at the healthcare facility can cancel the temporary worker order, wait until the scheduled healthcare worker arrives at the medical unit for the shift, or request the scheduler module or system to seek out an additional temporary staff person for that medical unit and shift.

It is a further object of the present invention to provide a time and billing system wherein the temporary workers are paid within 24 or 48 hours of their temporary employment at the healthcare facility.

### SUMMARY OF THE INVENTION

To summarize, the computer-based method for staffing and scheduling healthcare workers to fulfill healthcare staffing needs at a number of healthcare facilities includes providing a group of healthcare workers, each worker having a unique communications device consisting of one of a mobile Internet-enabled device, a cell phone or a tablet and each communications device providing unique GPS geolocation data for that worker. Each healthcare facility has an Internet-connected computer system. A scheduler database is operable with a scheduler computer system which computer is also Internet-connected. The healthcare worker communications devices, the scheduler computer system and the facility computer system independently communicate with each other. The worker profile data (see UPP Tables below) includes HC-W identifier data, medical qualification data, and worker availability data as a work calendar of available shift dates and times. Healthcare staffing requests are gathered, from a corresponding healthcare facility for one or more needed workers. The staffing requests include the number of needed workers, worker qualifications and facility shift date and time.

The scheduler database stores the worker UPP profile data, work calendar and the healthcare staffing requests. The method identifies a plurality of healthcare workers from the super plurality of healthcare workers who match both the staffing requests and the facility shift date and time using the scheduler database. Healthcare workers are notified, via the communications device, of a match between the respective worker calendar and the corresponding staffing request, and the corresponding healthcare facility data and shift date and time.

Within a predetermined response time, the scheduler accepts responses from the healthcare workers via the communications devices for the corresponding staffing request. The scheduler prioritizes worker acceptance responses for the staffing request based upon: worker quality of service factors, transit factors, and previous work histories at the healthcare facility, the quality of service factors and previous work histories. This data is stored in the scheduler database as worker profile data (the UPP). The scheduler then selects a sub-plurality of healthcare workers for the staffing request which matches needed workers at the healthcare facility as selected healthcare workers assigned to a selected shift at the corresponding healthcare facility. The selected workers are notified of the match and the specific shift via the worker communications device thereby filling the staffing request with a scheduled healthcare worker for the shift.

Within a predetermined antecedent time before each selected shift, the scheduler processor gathers GPS geolocation data from the scheduled worker's communications device. The processor and system monitors either a transit time or a transit distance from the current geolocation of the scheduled worker to the healthcare facility for the selected shift. In the event that either the transit time or the transit distance exceeds a dynamic predetermined time or distance factor, the scheduler generates an alert to both the scheduled healthcare worker and a shift manager. The alert to the scheduled healthcare worker is delivered via the communications device and is delivered to the shift manager. Data is stored in the scheduler database as a flag for the upcoming selected shift and in the worker UPP as a performance factor.

With respect to such events, the healthcare facility sends, for the upcoming selected shift, either a cancel worker command, a hold open worker command or a replace worker command for the upcoming selected shift. In the event of a replace command, the scheduler system repeats the identifying step, the matching worker step, the notifying the worker step, the accepting responses from worker step, the step of prioritizing, the selecting step and the notifying selected healthcare worker step for the upcoming selected shift.

In an enhanced embodiment, the method for staffing and scheduling includes notifying non-selected healthcare workers via the worker communications device for a particular shift. The worker profile data includes a work calendar which permits the worker to block OFF dates and shift times when the worker is not available for shift work. Also, the method includes blocking the identification of non-available healthcare workers who match both the healthcare staffing requests and the facility shift date and time using the scheduler database. Another enhancement includes monitoring workers who do not respond to notifications as the selected healthcare worker and annotating the worker profile UPP in the scheduler database of such non-response. Therefore, the healthcare workers are ranked by the scheduler system based upon responses and non-responses to the “job alert” notifications as a selected healthcare worker. These non-responses are ranked lower than positive “available” responses. A typical response time is less than 15 minutes.

As for time and billing functions, the system gathers, from the healthcare facility, clock-in and clock-out data for the scheduled healthcare worker for the selected shift. The system calculates the scheduled healthcare worker's pay for the selected shift at the healthcare facility. Then the system issues a pay order to the worker's bank enabling a deposit of the healthcare worker's pay into the worker's bank Typically, the pay order is issued not less than 48 hours after the selected shift ends. The system also calculates invoice data representing a service charge for the healthcare facility for the scheduled healthcare worker's attendance at the selected shift and presents the invoice data to the corresponding healthcare facility.

### BRIEF DESCRIPTION OF THE DRAWINGS

Further objects and advantages of the present invention are set forth in the detailed description of the preferred embodiments when viewed in conjunction with the accompanying drawings.

FIG. 1 provides a high level functional flowchart-type diagram of the basic operation of the automated scheduler system and method.

FIG. 2 diagrammatically illustrates the major components of the automated scheduler system and method.

FIGS. 3A through 3D diagrammatically illustrate the process flowchart for the automated scheduler system and method.

FIGS. 4A, 4B, 4C and 4D diagrammatically illustrate the healthcare facility dashboard, staff module, and various functional block add-ons.

FIG. 5 diagrammatically illustrates the RN or healthcare worker app. This app is deployed on the smart phone communications device of the healthcare worker.

FIGS. 6A and 6B show the healthcare facility process.

FIG. 7 shows an enhanced scheduler program module.

FIGS. 8A, 8B and 8C show a time, billing and payment program.

FIG. 9 diagrammatically illustrates a distributed system utilized in conjunction with the billing and payment program.

### DESCRIPTION OF EMBODIMENTS OF THE PRESENT INVENTION

The present invention relates to an automated healthcare scheduler system and method. Similar numerals designate similar items throughout the drawings of the automated scheduler system and method. The Abbreviations Table near the end of this description provides some correspondence between abbreviations and terms.

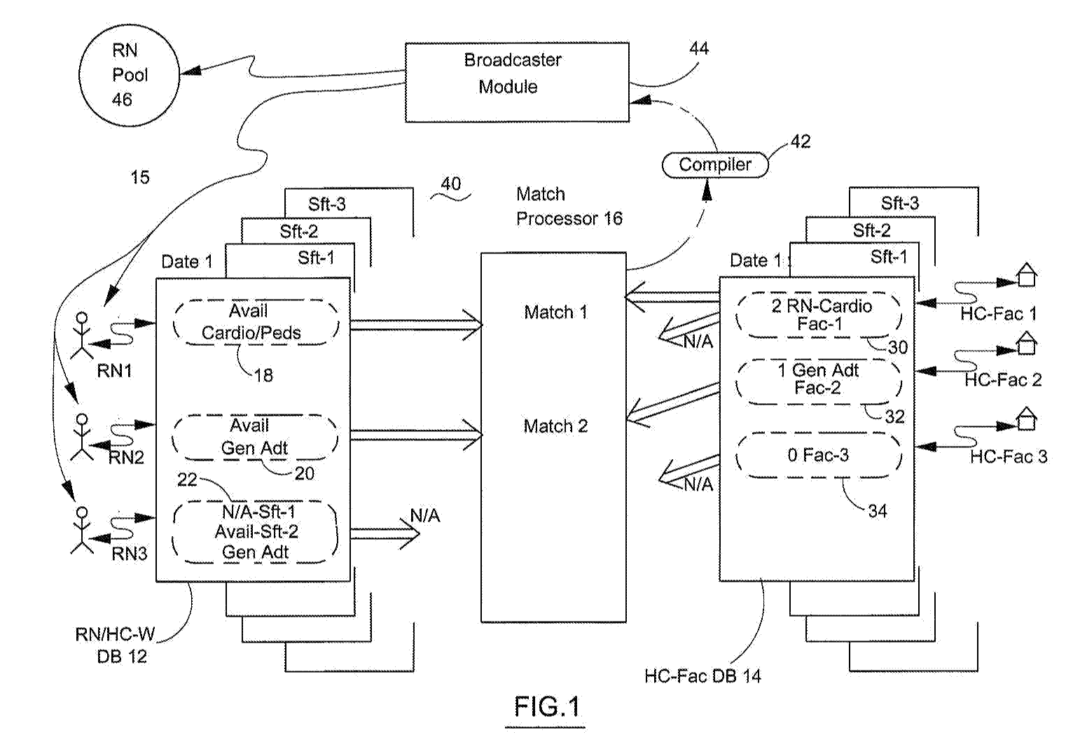

FIG. 1 generally shows a high level functional diagram of the system and method. On the healthcare staffing supply side, the registered nurse—healthcare worker database 12 (RN/HC-W DB 12) is linked via a telecommunications network 15 to various healthcare workers (RN/HC-Ws) which are shown in FIG. 1 as RN 1, 2, 3. These registered nurses, for example RN1, have completed a user personal profile (UPP, see UPP Table 1 below) which is stored in RN/HC-W database 12. Some of the RN UPP profile is discussed later herein and includes an individualized RN/HC-W worker scheduler-calendar unique to each healthcare staffer. The RN/HC-W worker scheduler-calendar is uploaded to the RN cell phone, smart phone or the Internet-enabled Device (IED).

RN pool 46 is also shown as a temporary staff supply for health care facilities (HC-Facs). It should be noted that any type of licensed healthcare worker or staffer can utilize the present system and method. FIG. 1 is a general example of the system operating in conjunction with registered nurses.

In connection with RN 1, that person has indicated his or her availability as a licensed healthcare professional in a cardiac unit or a pediatric unit. See RN-UPP below. That availability or “avail” entry 18 is unique to a certain date, date1, and a certain shift, shift1 (date1/shift1). DB entry 18 is unique to RN1. Entry 20 is limited to RN2 and entry 22 is limited to RN3. Common healthcare shifts are 7 AM-3 PM; 3 PM-7 PM and 11 PM-7 AM.

RN 1 has indicated his or her available availability for Date1, Shift1 in database 12 at RN UPP entry 20. Registered nurse 3 is not available as noted in UPP entry 22 for Shift 1, but is available for Shift 2 in the general adult population at an HC-Fac. The registered nurse—healthcare worker database RN/HC-W DB 12 also is configured for Date1, Shifts 1, 2 and 3.

Examples of the RN UPP are shown in the following table. “Date #” refers to a date code. “DQ” refers to a marker that the HC-W should no longer work at the HC-Fac. The Q or quality scores are discussed later.

TABLE 1
RN User Personal Profile (UPP) Table (example)

name, address; phone
age
Background data (verified)
certifications
workers comp
malprac insurance
Med. Specials: HEMOC; Cardio; Peds
current Geo-loc at Date/time
Alert Status: On Time; In Transit; Delay Short;
Delay Long; Cancel En Route
Mgt Alert Record: Delay Short date1, date2;
Delay Long date4; Cancel En Route NULL
Payroll data: hours worked data, paycheck data,
direct deposit data
Recent work history (e.g., past year):
HC-Fac A, HEMOC: date1 Q-scoreA; date2 Q-scoreA;
date3 Q-scoreB
HC-Fac A, Cardio: date5 Q-scoreC; date12 Q-scoreB;
date32 Q-scoreD
DQ history: (a) HC-Fac A, Cardio;
RN Exclusions: (i) HC-Fac 78; (ii) Exclude all Fac
EmergencyCare
UPP Schedule - link to RN Staff DB

The following is an example of a health professional UPP personal scheduling calendar.

TABLE 2
UPP Schedule RN-Jane Doe 123456 (example)
Week 45 (from work week 1 to work week 52)

| Mon | Tues | Weds | Thurs | Fri | Sat | Sun |
|---|---|---|---|---|---|---|
| Sft-1 - N/A | Sft-1 - | Sft-1 - | Sft-1 | Sft-1 | Sft-1 | Sft-1 |
| | N/A | N/A | | | | |
| Sft-2 - avail | Sft-2 | Sft-2 | Sft-2 - | Sft-2 - | Sft-2 | Sft-2 |
| | | | N/A | N/A | | |
| Sft-3 - avail | Sft-3 | Sft-3 | Sft-3 | Sft-3 | Sft-3 - | Sft-3 - |
| | | | | | N/A | N/A |

The following is a healthcare worker personal profile table.

TABLE 3
Healthcare Worker (HC-W) User Personal
Profile (UPP) Table (example)

name, address, phone
certifications
Medical Units: Gero; Peds; Ortho
age
Background data (verified)
current Geo-loc at Date/time
Alert Status: On Time; In Transit; Delay Short; Delay Long;
Cancel En Route
Mgt Alert Record: Delay Short date1, date2; Delay Long date4;
Cancel En Route NULL
Payroll data: hours worked data, paycheck data
Recent work history (e.g., past year):
HC-Fac A7, Gero: date1 Q-scoreA; date2 Q-scoreA;
date3 Q-scoreB
HC-Fac A213, Peds: date5 Q-scoreC; date12 Q-scoreB;
date32 Q-scoreD
Fac Comments: HC-Fac B3: xxx; HC-Fac G1234: yyy
Active/Inactive Status
DQ history: (a) HC-Fac A, Cardio; (b) HC-Fac DD: DNR (do not return)
(c) HC-Fac: all Fac EmergencyCare
UPP Schedule (see HC-W UPP) - link to HC Staff DB

On the healthcare facility side, HC-Facs 1, 2, 3 have uploaded into healthcare facility database 14 their respective requirements or staffing requirements for Date 1, Shift 1, 2 and 3. Facility 1 has posted a staffing requirement for two registered nurses in the cardiac unit at the staffing requirement database entry 30. Healthcare facility 2 has posted a staffing requirement at record 32 for a nurse in the general adult population. Facility 3 has indicated zero (0 or null) staffing needs for Date 1, Shift 1.

After the facilities post their staffing needs, Match Processor 16 matches qualifications of the RN/HC-W with the staffing requirements for the HC-Facs. For example, one hundred RN/HC-W may be located as potential staffers for the staffing events in the HC-Fac DB 14 (a super plurality). Compiler 42 then organizes the potential “available” staff data by date and shift and qualifications and the system 40 activates broadcast module 44. Other match characteristics are discussed later. Broadcast module 44 then sends text messages or other types of activation telecommunication messages to various qualified RN/HC-Ws, nurses or healthcare workers, in this case, RN 1, 2, 3 (a plurality of initially selected RNs). Other broadcasts can be submitted to the registered nurse pool 4.

RNs 1, 2, 3 gets an audio alert and/or a visual alert on his or her Internet enabled device IED cell phone, which typically is a smart phone. Communications with the scheduling system may be via an RN desktop computer or RN computer tablet operated by the RN (HC-W).

Once RNs 1, 2, 3 sees or hears the audio-visual AV alert from broadcast module 44, he or she can look at the staffing requirement posted by the scheduling system 40. As explained later, the healthcare professional can have an option on the cell phone IED and the Scheduler APP to locate the healthcare facility and review the temp job that is posted the staffing requirement. In other words, the potential RN/HC-W staffer can check and view the details of a certain HC facility before selecting the “I am Available for this Shift” (Avail) button on the Scheduler APP. One or more of the registered nurses may respond to the staffing requirement alert by selecting an appropriate button or communications activation point on the cell phone IED via the Scheduler APP.

In the system described in FIG. 1, match processor 16 coordinates a selection by RN 1, now called a “selected staffer”, to match one of the needs for healthcare facility 1 for the cardiac unit. However the other staffing requirement for the cardiac unit, as noted in database entry 30, is not filled and therefore is marked “not available” or “N/A” or “no staff available.” This data is made available to the HC-Fac Manager at his or her dashboard.

If more RNs (HC-Ws) have accepted the HC-Fac's staffing request, the match processor 16 prioritizes the results as shown below. The system operator may change these priorities.

Priority Staffing Table

1. Optional: geographic proximity
2. Certification level (highest priority)
3. Quality Score levels (see below)
4. Days/shifts worked at Fac (quantity factor)
5. Late arrival factor (a negative score event)
6. Number of disqualifications (a negative score event)
7. Number of shifts worked that week

The RNs with the highest scores are selected for the staffing event at the HC-Fac.

With respect to RN 2, he or she has also selected the “I Accept” button responsive to the broadcast and the match via match processor 16 for filling a staffing requirement for healthcare facility 2, and, more particularly, the staffing requirement entry 32. RN 3 has not been staffed for Date 1, Shift 1 as noted by the not available marker N/A in his/her schedule. RN2 is then a selected HC-W.

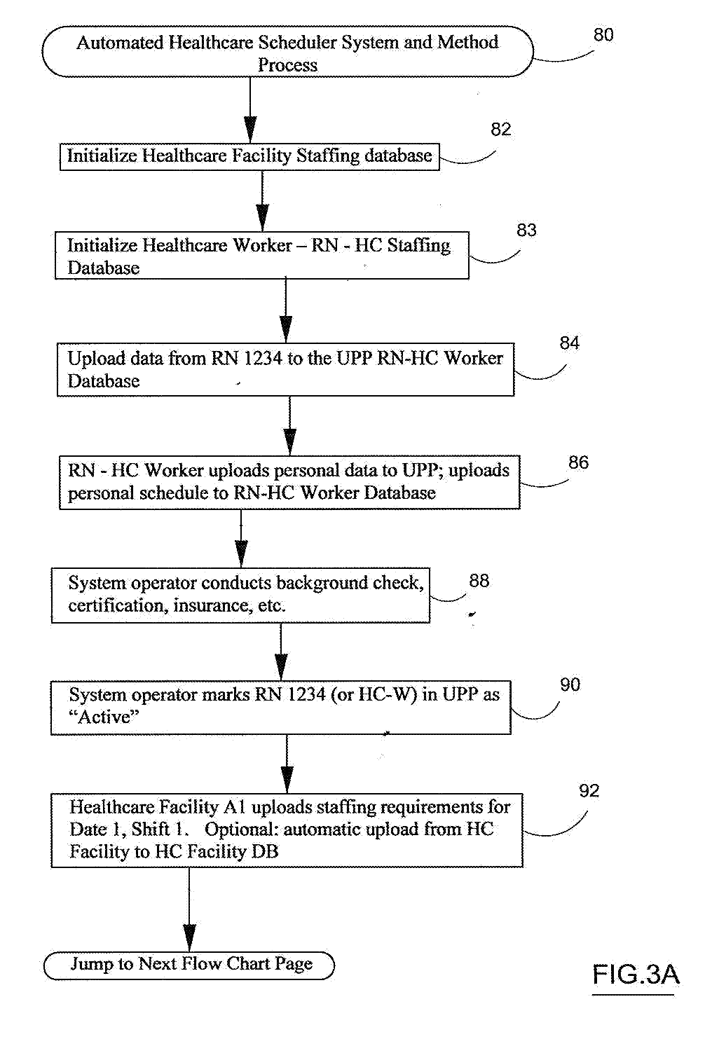

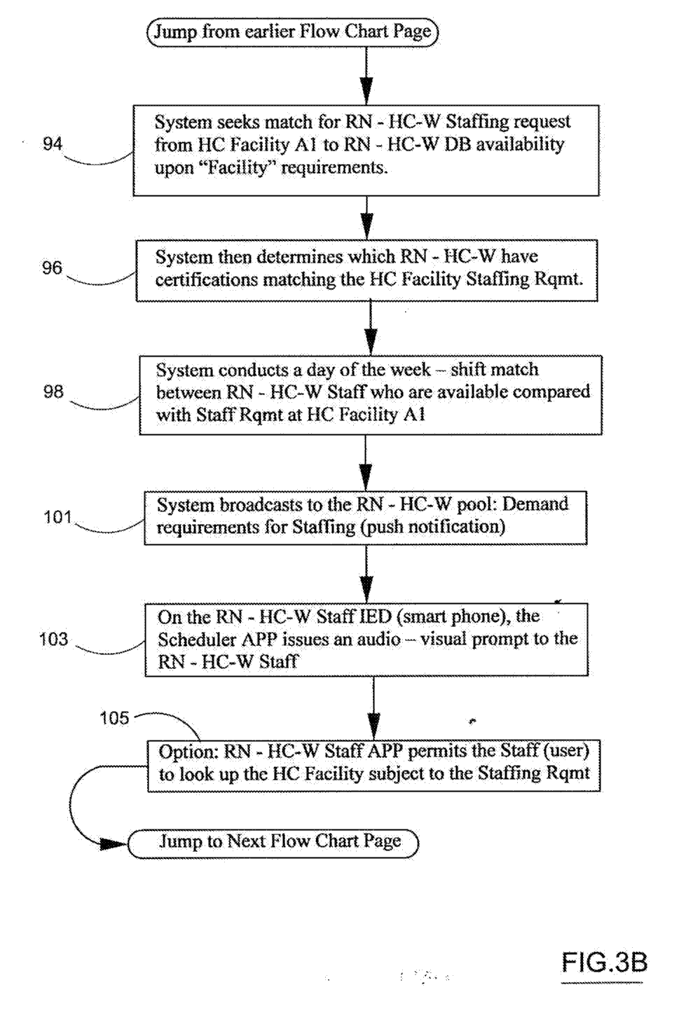

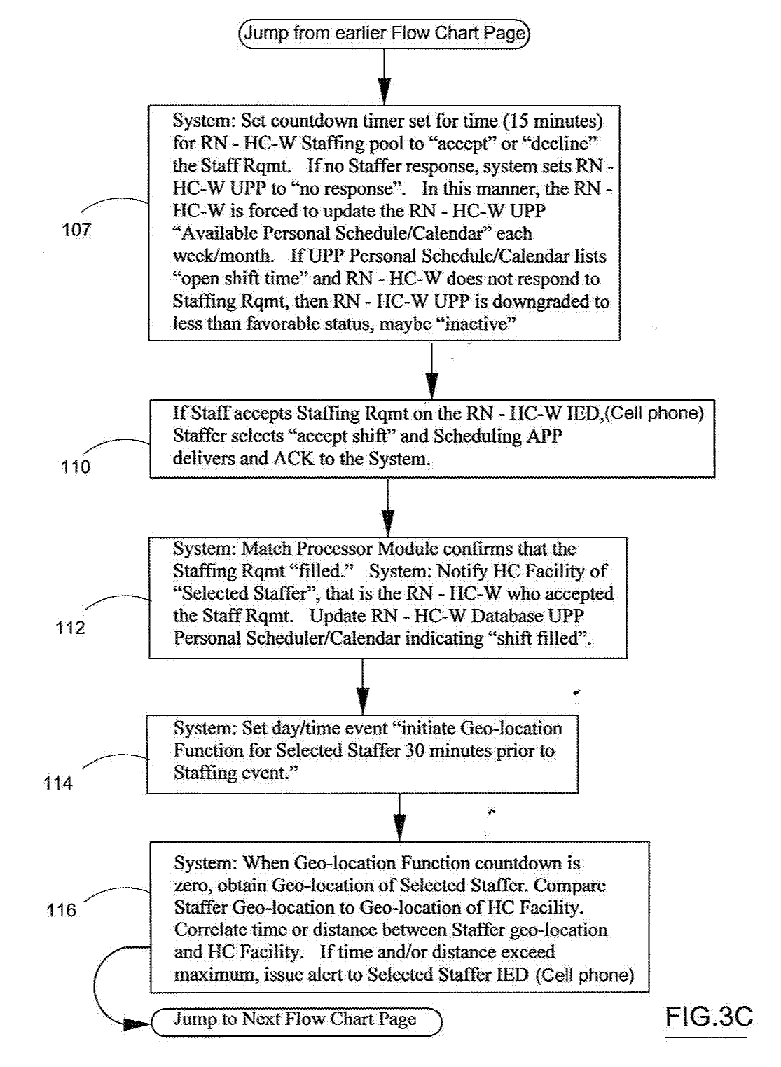

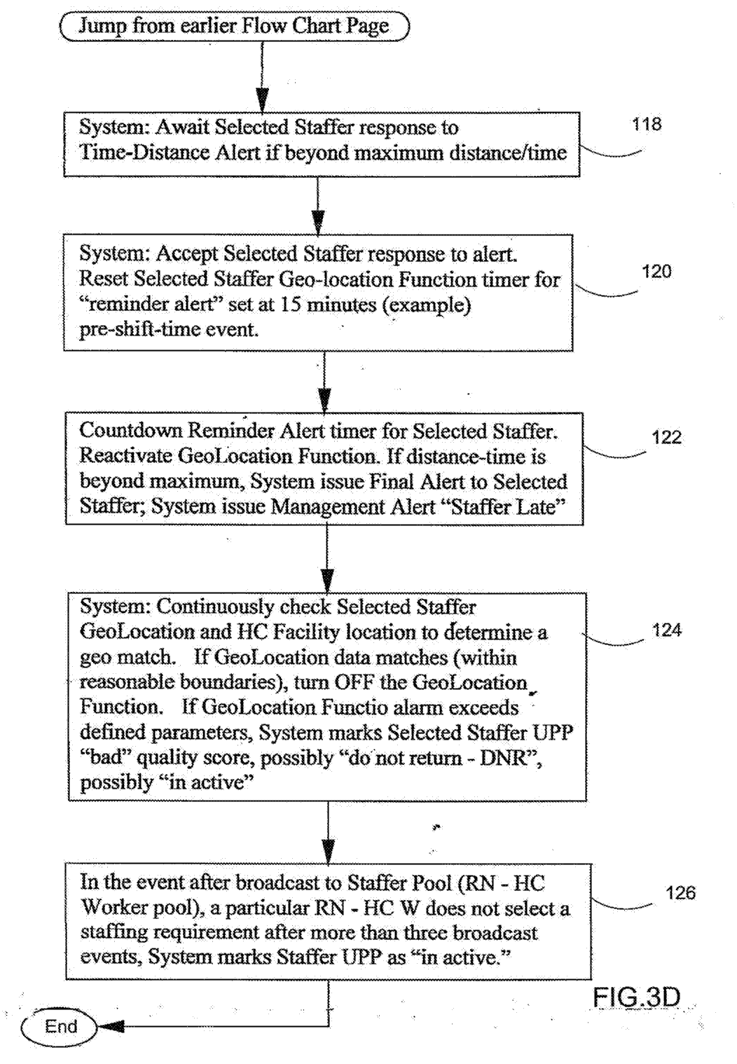

As described later in connection with the flowchart automated healthcare scheduler system and method process in FIGS. 3A through 3D, the healthcare worker is assigned a quality score by the healthcare facility at the end of his or her HC-Fac shift. The following Quality Score Table provides an example.

Quality Score Table (example)

| | |
|---|---|
| Q-score A | top score 1 out of 1-5 |
| Q-score B | top score 2 out of 5 |
| Q-score C | top score 3 out of 5 |
| Q-score D | top score 4 out of 5 |

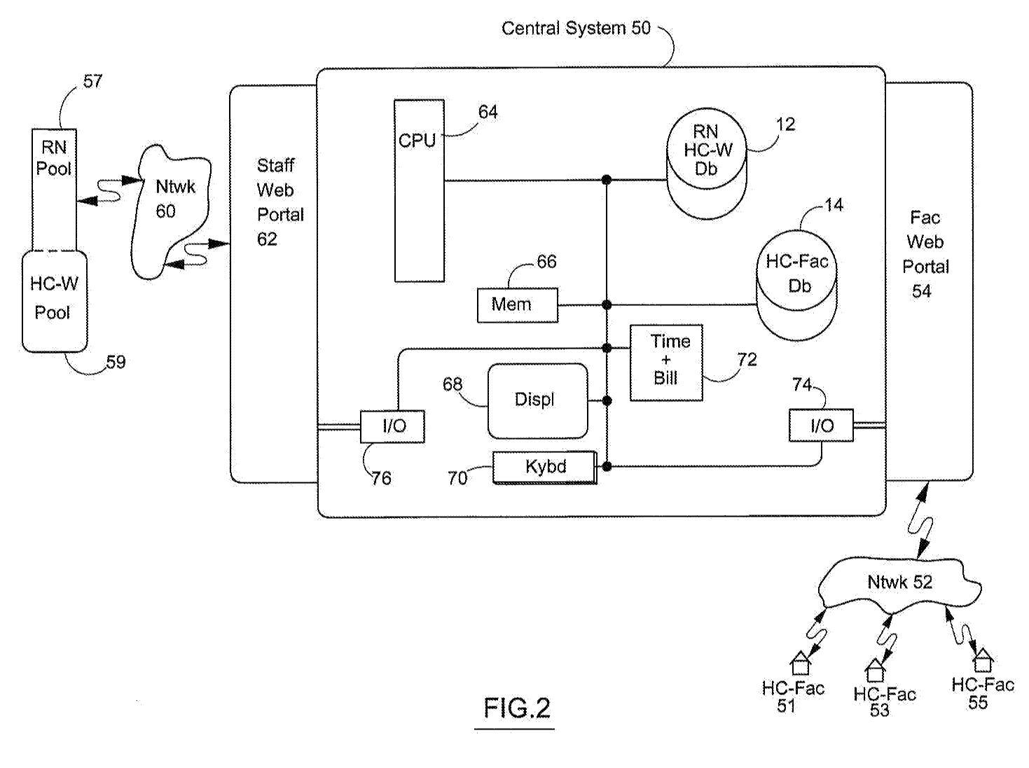

FIG. 2 diagrammatically illustrates the major computational and functional modules for the present invention. The central system 5 includes, on the healthcare facility side, a facility web portal 54. Portal 54 communicates with healthcare facilities 51, 53, 55 via telecommunications network 52.

On the staffing side, the central system 50 includes a staff web portal 62. Registered nurse pool 57 permits various registered nurses to access the central system 50 via telecommunications network 60. Other healthcare workers are diagrammatically illustrated as healthcare worker pool 59.

Central system 50 includes input-output modules 76, 74 respectively handling communications from the facilities web portal 54 and staff web portal 62. These I/O devices are connected to a bus which is also connected to a CPU 64, a memory 66, a time and billing sub-system module 74, and two databases 12, 14. RN-HC-W database 12 is discussed above in connection with FIG. 1 and in the various tables. Healthcare facility database 14 accepts data transfers and the CPU 64 controls inputs and outputs to the various healthcare facilities 51, 53, 55. Shift alerts to HC-W may be an SMS or text. The I/O may be internet router modules.

The system operator can have access the various electronic components in central system 50 via display panel 68 in keyboard or keypad 70.

In more detail, FIGS. 3A, 3B, 3C and 3D diagrammatically illustrate the automated healthcare scheduler, system, method and program 80. In step 82, the healthcare staffing database is initialized. In step 83, The healthcare worker staffing database is initialized. Step 84 involves uploading data from registered nurses and, in the diagram, nurse 1234, into the healthcare worker database. In step 86, the RN or healthcare worker uploads personal data into his or her UPP. Importantly, the healthcare worker uploads his or her personal work avail schedule into the worker database. The system operator (Sys op), in step 88, conducts a background check, a certification check, and an insurance check and other on-boarding data and uploads the data for the RN or HC-W. Some system data in the UPP may be hidden from the HC-W. In step 90, The system operator marks RN 1234 in his or her UPP as an “active” HC-W.

In step 92, healthcare facility Al uploads its staffing requirements for a certain date and a certain shift. Optionally, the scheduler system may seek an automatic upload from the healthcare facility or from the facility's database. Jump points are illustrated between FIGS. 3A, 3B, 3C and 3D.

In step 94, the system seeks a match for the healthcare staffing request from the healthcare facility, and the RN or healthcare worker availability list. Part of this availability function is based upon the geographic proximity of the healthcare worker to the facility. In a preferred embodiment, the healthcare worker's cell phone must have activated its geolocation module turned ON. In this manner, when the healthcare worker is “available” for staffing position, the scheduler software and system can match the then current location of the healthcare worker with the healthcare facility. Subject to a worker's qualifications, skill level and work activity, the geographic preference is to seek out and match healthcare workers which are closer to a healthcare facility than others which are further away.

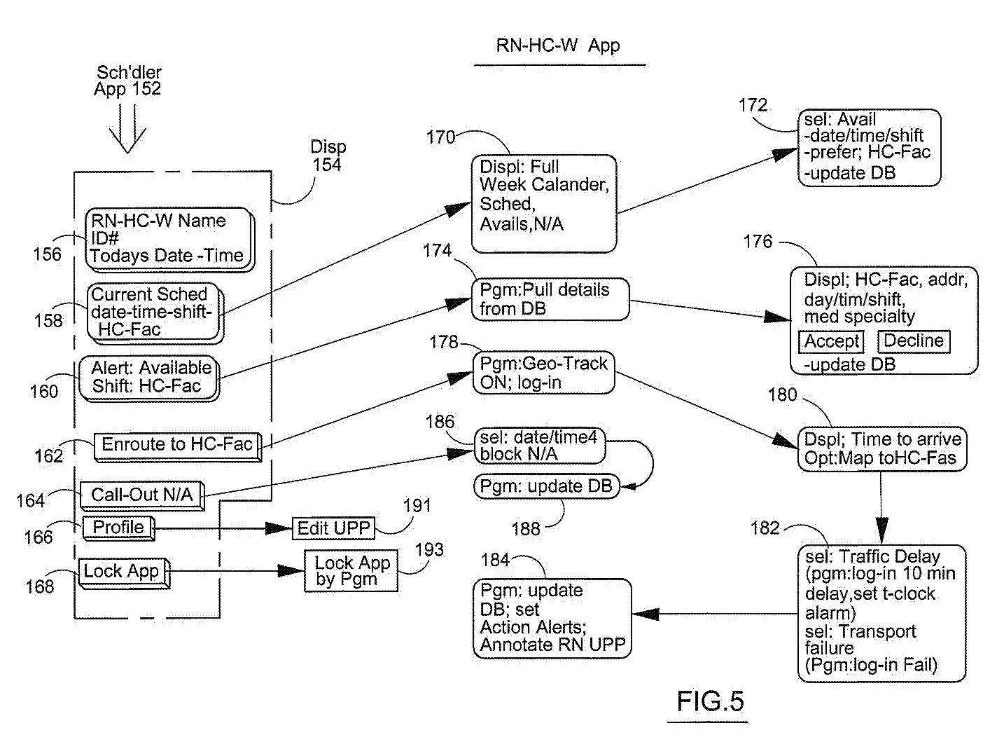

In step 96, the system then determines which healthcare workers have certifications matching the staffing requirement. In step 98, the system conducts a day of the week and shift match between RN and the worker staff who are “available” compared with the staffing requirements at the healthcare facility. In step 101, the system broadcasts to the RN or healthcare worker pool the demand requirements for staffing. Preferably, this is a push notification. Further details of this function are described later in connection with FIG. 5. In step 103, the healthcare workers cell phone is activated and the APP on the phone issues and audio and/or visual prompt to the healthcare worker. Optionally in step 105, the healthcare worker APP permits the user or healthcare worker to look up the healthcare facility which is requesting the staffing requirement. In this manner, the healthcare worker can view or see specific details regarding the medical unit and the healthcare facility in general prior to responding to the “staff needed” broadcast from the scheduler system. The location and type of temp staff work is important to the HC-W.

In step 107, the scheduler system sets a countdown timer from the initiation of the broadcast to the healthcare worker staffing pool. In one embodiment, a 15 minute countdown timer is utilized by the scheduler system. Within this predetermined time frame which may be changed by the Sys Op, the healthcare workers can accept or decline the staffing request. If there is no response from the healthcare worker's cell phone, via the APP, the system sets the particular healthcare worker UPP to “no response.” In this manner, the healthcare worker is forced to update his or her UPP and the “available personal schedule or calendar” each week or month or other predetermined period of time. Further, the HC-W should positively look for staff alert openings since calls for staffing typically are made in certain day/time frames prior to the temp job, for example, 24 hours prior to the day/shift time. If the healthcare worker UPP personal scheduler lists an “open shift time” (Avail), and the healthcare worker does not respond to a broadcast staffing requirement, the particular healthcare worker UPP is downgraded to a less than favorable status and ultimately may be downgraded to an inactive status.

The Table that follows is an example of the downgrade system.

Decline Staffing Request (RQT) Table

Decline Record (last 30 days)
1st: pass - no action; log in RN (HC-W) UPP
2nd: Text Mess: Need Program Training
3rd: mark RN UPP “not responsive”
4th: mark RN UPP: 2nd Not Responsive;
text RN: Call Sched'r Mgr NOW
5th: mark RN UPP: “Inactive”

In step 110, if the healthcare worker accepts the staffing requirement on his or her cell phone or Internet enabled device (such as a computer or computer tablet), the staffer selects “except shift” and the scheduler APP delivers an acknowledgment to the scheduler system. In step 112, the match processor in the scheduler system confirms that the staffing requirement is filled with the HC-Fac portal or the HC-Fac computer-based system.

At a later time closer to the scheduled shift for that healthcare worker, the scheduler system sets a day and time event to initiate the geolocation capture function for the selected staffer a certain period of time prior to the shift. In general, the scheduler system has data regarding the current residential address of the healthcare worker. The scheduler system also has data regarding the geographic location of the healthcare facility. With some basic knowledge of the time to travel from the healthcare worker's location to the healthcare facility such that the worker appears at the facility on or before the scheduled shift time, the scheduler system can establish a trigger time event to initiate HC-W geolocation search and upload the geolocation of the healthcare worker prior to the scheduled shift time. In step 116, when the geolocation function countdown is zero or null, the scheduler system obtains a geolocation of the selected staffer via the staffer's cell phone. This staffer geolocation is then compared with the location of the healthcare facility. The scheduler system correlates the time and the distance and the travel time between the staffer's geolocation and the healthcare facility. If the time or distance exceeds a maximum, the scheduler system in a sophisticated embodiment, may issue an alert to the selected staffer's cell phone. The trigger alarm may also be sent via the scheduler processor to a staff manager for intervention with the assigned HC-W and/or with the manager at the HC-Fac. The trigger alarm threshold is a dynamic threshold which changes based on time and/or distance. An example is set forth below in the Table.

Dynamic Time or Distance Factor Table

| | |
|---|---|
| Base Distance between HC-W Home GeoLoc | 22 mi. |
| and HC-Fac A: | |
| Rush hour transit time to travel from HC-W | 45 min. |
| Home GeoLocand HC-Fac A: | |
| Park and walk to shift building/floor time: | 5 min. |
| Shift Time: | 7:00 AM |
| Antecedent Time Alarm set 10 min. before HC-W | 6:00 AM |
| time to leave home | |
| Dynamic Temporal Factor 1 (e.g., 15 min cycles): | HC-W geoloc |
| | 14.7 mi. to HC-Fac |
| Dynamic Temporal Factor 2: | HC-W geoloc |
| | 7.3 mi. to HC-Fac |
| Dynamic Temporal Factor 3: | HC-W geoloc |
| | 0 mi. to HC-Fac |
| Dynamic Spatial Factor 1 (e.g., 15 min cycles): | HC-W geoloc |
| | 14.7 mi. to HC-Fac |
| Dynamic Spatial Factor 2: | HC-W geoloc |
| | 7.3 mi. to HC-Fac |
| Dynamic Spatial Factor 3: | HC-W geoloc |
| | 0 mi. to HC-Fac |

In step 118, the scheduler system awaits the selected staffer's response to a time and distance alert if the staffer is beyond the maximum distance or time calculated by the scheduler system. In step 120, the system accepts the selected staffer's response to the alert. The system resets the geolocation function timer function for that selected staffer and resets a reminder alert at, for example, 15 minutes prior to the shift time event. In step 122, the countdown reminder alert timer for the selected staffer is activated. The system reactivates the geolocation function to locate the current location of the staffer. Alternatively, the geolocation function in the scheduler system may continually ping or gather the geolocation of the selected staffer while he or she is in transit to the healthcare facility. If the distance and/or time is beyond a maximum limit, which may be dynamically reset dependent upon the transit time and the traffic, the system may issue a final alert to the selected staffer. With this final alert to the selected staffer, the system also issues a management alert that the staffer may be late. This “late alert” may also be sent by the scheduler program to the healthcare facility. The late alert program table which follows provides an example.

Late Alert Program Table (steps a through m)

(a) Sched'lr Sys: 30 minute prior to date/shift: poll RN and
obtain geo loc data.
(b) Sched'lr Sys: if time to arrive at HC Fac geo loc greater
than pre-set margin from RN geo loc, then send alert to RN;
note “late alert RN-HC Fac” in daily sys.
(c) Sched'lr Sys: await response from RN.
(d) Sched'lr Sys: If no RN response in pre-set time, send 2 nd
RN alert, trigger Sched'r Mgr “call RNs”.
(e) Sched'lr Sys: If no Sched'r Mgr override, then send
alert “RN Late” to HC-Fac, send 2nd trigger to
Sched'r Mgr “call RN”.
(f) Sched'lr Sys: await HC-Fac response to “late alert”.
(g) HC-Fac Sys: HC-Fac Mgr select “cancel staffer”
or “hold,” “send RN backup” “Replace”.
(h) Sched'lr Sys: respond to HC-Fac Mgr selection.
(i) From RN Phone: “Traffic Delay”: Sched'lr Sys:
activate steps b, e (override).
(j) From RN Phone: “Traffic Delay Second Time”:
Sched'lr Sys: activate steps e, f, g, h (notify HC-Fac)
(k) From RN Phone: “Transport Failure”: Sched'lr Sys:
activate steps e, f, g, h (notify HC-Fac).
(l) Sched'lr Sys: If “Transport Failure”: Schd'r Mgr
arrange alternative transport, facilitate auto-accident, etc.,
respond to HC Fac step g.
(m) From HC-Fac: If “replace”, Sched'lr Sys: generates
broadcast to RN Available list for date/shift.

In step 124, the system continually checks the selected staffer's geolocation in order to determine when the staffer reaches the location of the healthcare facility. When the geolocation data of the staffer in the healthcare facility match, within some reasonable boundaries, the scheduler system turns OFF the geolocation function directed to that particular staffer. In a different situation, if the geolocation function indicates an abnormal or excessive time or distance, such that this time or distance exceeds certain predefined parameters, the system may mark the selected staffer UPP with a bad quality score. This quality score may be a “do not return” or possibly an inactive status.

The selected HC-W may send a transport failure message to the scheduler and the scheduler reacts as indicated above.

In step 126, in the event after a broadcast to a staffer pool, a particular healthcare worker does not select the staffing requirement when that worker UPP has indicated “available” for that staffing event, if that healthcare worker does not respond to the broadcast within a predetermined number of broadcast events, such as three broadcast events, the scheduler system marks the staffer UPP as inactive. The decline staffing request Table set forth above provides more examples of this feature.

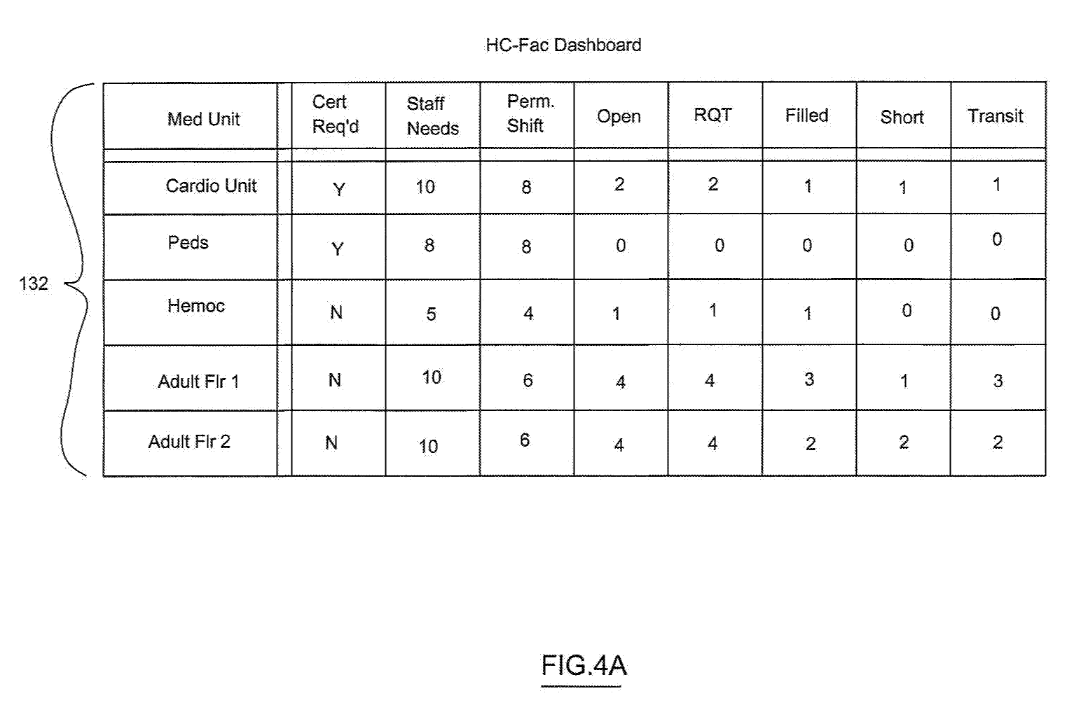

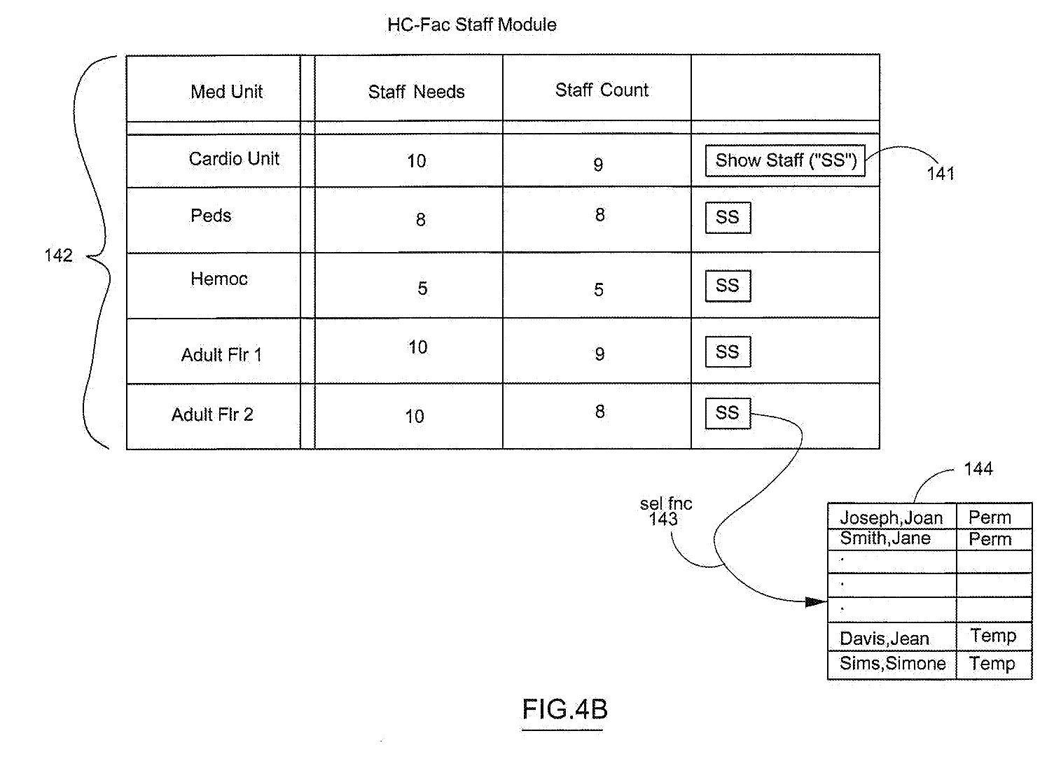

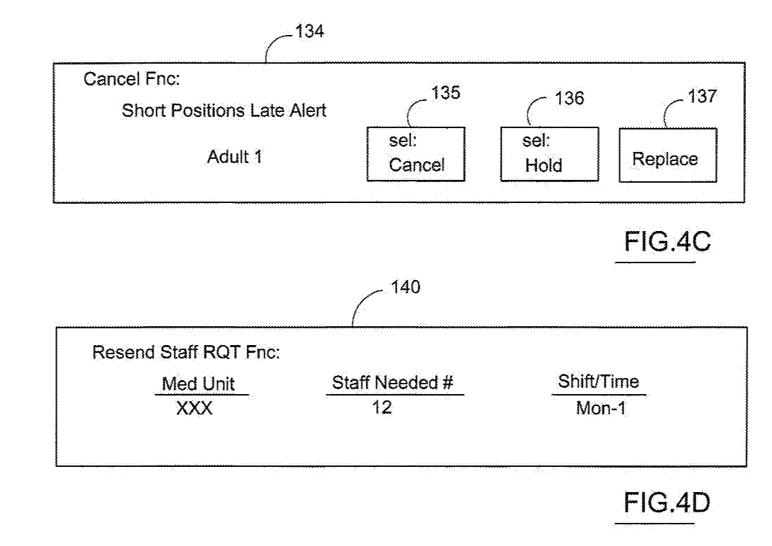

FIGS. 4A, 4B, 4C and 4D diagrammatically show some examples of the healthcare facility dashboard, a HC-FAC staffing module, a cancellation function module, a hold open staff request, and a resend staff request function module. In FIG. 4A, display 132 includes column headers such as: medical unit, certificate required, staffing needed, permanent staff available, open staffing positions, request for temporary staff count, filled staff request count, short staffing count, and temporary staffers in transit. The rows are identified by examples of medical units such as a cardiac unit, a pediatric unit, a hematology unit, and adult floor 1 and adult floor 2. As can be seen, the adult floors do not need staffers who have certain certificates or qualifications. In contrast, the cardio floor does need certified staffers. The pediatric floor is fully staffed with permanent staffers but the cardiac unit has 2 open positions for temporary staffers, a request is open for 2 temporary staffers, and only 1 temp staff position is filled. A healthcare worker is in transit to that medical unit.

FIG. 4B shows a health care facility staff module with the display 142. In column format, the display shows medical unit, staffing needs for that unit, a current staff count. The upper far right block 141 is a selectable function button or element which permits the health care manager to select a “show staff” function. When function 143 is selected, the selection function is activated and a box 144 is displayed showing the names of the staff for that medical unit as well as whether each staff member is a permanent or temporary position.

FIG. 4C shows a cancellation function 134. In this function block, “short positions” and “late alert” notifications are shown. Although adult floor 1 is shown, multiple medical units could be shown in the cancellation function display. The user or health care HC-Fac manager can select one of the functions 135, 136, 137 which, upon selection of that function, cancels the temporary staffing request, keeps that request “on hold” and open for the selected staffer to arrive at the medical unit, or provides an instruction/command to the scheduler system to replace the temporary staffer which has been selected for that shift.

FIG. 4D is the resend staff request function. In display 140 the column format shows medical unit, and a staff needed count in the current shift in time. In this manner, the health care manager can select a button command (see FIG. 4C) to resend a staff request to the scheduler system.

FIG. 5 shows a healthcare worker APP which is placed on the healthcare worker's cell phone. Scheduler APP 152, as an example, includes display 154 screen. That display has, by example, certain information areas. In information area 156, the health workers name and ID as well as the date and time is shown. In area 158, the healthcare worker's current schedule, date and time and shift for a particular healthcare facility is shown. This is the current or next shift schedule for the healthcare worker. By activating display region 158, the APP executes step 170 which displays a full calendar or work week, all the shift schedules for that particular healthcare worker, and all “available” days and shifts and all “not available” or N/A days and shifts. In step 172, the healthcare worker can select, as being “available,” any day, time and shift and, in an advanced system, can establish preferences for healthcare facility. As a result of the healthcare workers input into functional block 172, the scheduler system database is updated. Data is pulled from the HC-W cell phone by the scheduler program. See FIG. 2.

Returning to display 154 and in display region 160, alerts are provided to the healthcare worker. These alerts are for available shifts which alerts are broadcast by the scheduler system. Once selected by the worker, in step 174, the APP program pulls details from the scheduler database. These alerts, as shown in display region 160, are the broadcast alerts for an available shift at a certain healthcare facility. In step 174, the APP pulls the shift details from the scheduler database. In step 176, the healthcare facility address is displayed, the HC name is displayed, and the to-be-filled shift and any medical specialty. The healthcare worker can accept or decline as noted by the function blocks in FIG. 5. Accordingly, the scheduler database is updated.

Returning to display 154, in function block area 162, this function block is activated when the healthcare worker is enroute to a particular healthcare facility. In step 178, the APP program turns ON the geo-tracking of the cell phone. Further, the cell phone of the healthcare worker logs into the scheduler system. In step 180, the display on the cell phone shows the time to arrive and optionally shows a map to the healthcare facility. The map may show the best route to get to the HC-Fac from the current geolocation of the worker. In step 182, the healthcare worker can select a “traffic delay” event module which provides an indication to the scheduler system. At that time of the traffic delay, the program will login a 10 minute delay and set a timer clock alarm on the cell phone to notify the healthcare worker of the 10 minute countdown for the traffic delay. Any countdown time may be used. The purpose of the countdown time is to permit the user HC-W to notify the scheduler system of a larger traffic delay problem. Hopefully, the manager at the HC-Fac will not cancel the worker's shift and further the HC-W will not be downgraded as being late to the shift. Further, in step 182, the healthcare worker can select a transportation failure. In the event of such a failure, the program logs in a “transport failure” error message to the scheduler system. The transport failure table which follows provides examples. In step 184, the program updates the database, sets action alerts, and annotates the healthcare workers UPP.

Transport Failure Table

Input from RN Phone:
flat tire
car disabled
accident
other (RN to complete text input)
RN Select: Send alternate transport

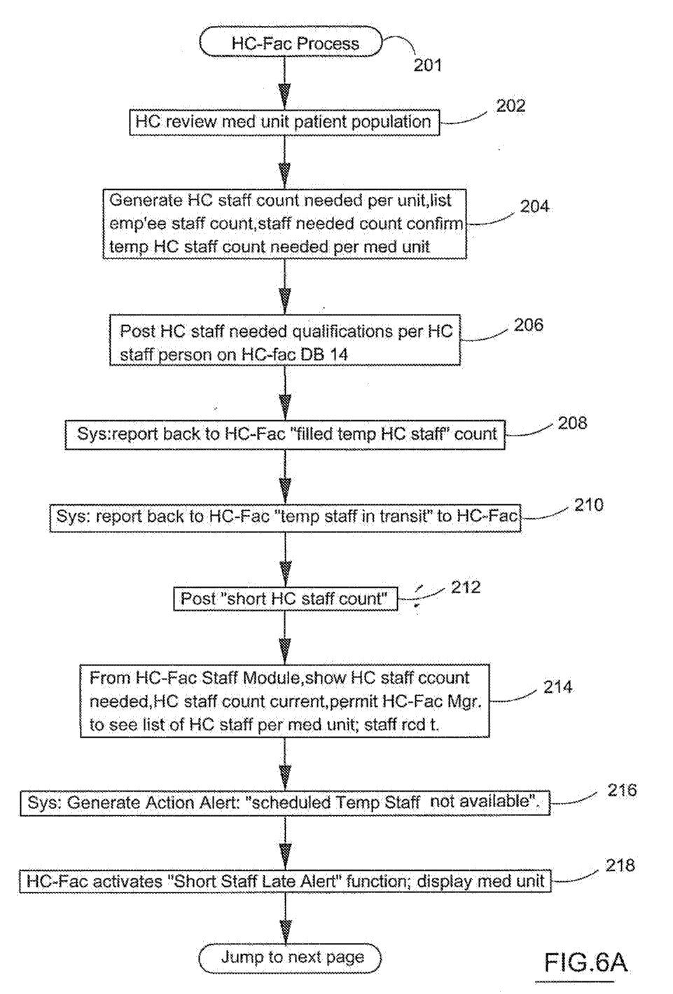

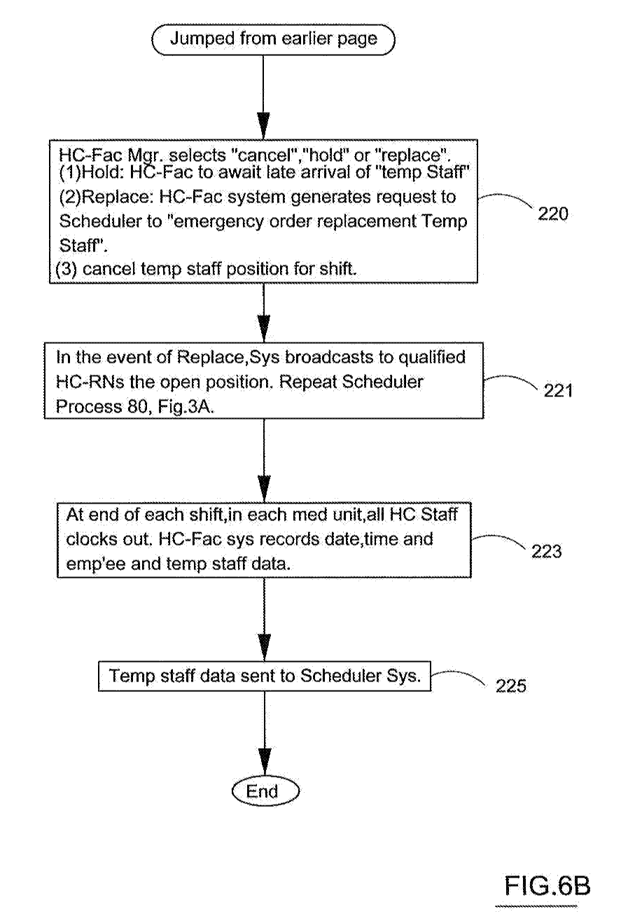

FIGS. 6A and 6B diagrammatically show processes for the healthcare facility. Process 201 begins in step 202 where the health care manager reviews each medical unit patient population. In step 204, the manager or the healthcare facility system generates a staff count needed on a per medical unit basis, lists the employee staff count, the staff needed count, and confirms the temporary healthcare staff count needed for each medical unit. In step 206, the manager posts the healthcare staff needed and also posts the qualifications for each staffperson in the healthcare facility database 14. See HC-Fac portal in FIG. 2. In step 208, the system reports back to the healthcare facility the scheduler system has filled a temporary healthcare staff count. In step 210, the scheduler system reports back to the healthcare facility a note that the temporary staff is “in transit” to the healthcare facility. In this manner, the healthcare facility is kept apprised, in substantially real time, of the ability of the scheduler system to fill open staffing requirements for each medical unit. In step 212, the healthcare program posts the short staff count. In step 214, from the healthcare staff module, the module shows the staff count needed, the current staffing for that medical unit, and permits the health care manager to see the list of staff for each healthcare unit. Also, when the temporary workers and the permanent employees begin their respective shifts, the system logs in or clocks-in the worker and the shift and the medical unit. In step 216, the system generates an action alert that a certain temporary staff is “not available.” In step 218, the healthcare facility generates a short staff late alert and this alert is displayed on the facility dashboard on a per medical unit basis. A late alert means that the HC-W did not clock in on time at the assigned shift.

In step 220, the facility manager selects cancel, hold or replace for that late temporary worker alert. The “hold” indicates that the manager will await the late arrival of the temporary staff The “replace” module generates a request to the scheduler system to broadcast an emergency request for replacement of temporary staff. This activates the resend staff request function. The “cancel” module cancels the temporary staff position for that particular shift and for that particular medical unit. In step 221, in the event of a replace command, the scheduler system broadcasts to qualified healthcare workers and nurses that an open position is available. The system then repeats the scheduler process 80 in FIG. 3A. In step 223, at the end of each shift, in each medical unit, all workers clock out. The facility records the date, time, employee and temporary staff data. In step 225, the temporary staff data is sent to the scheduler system.

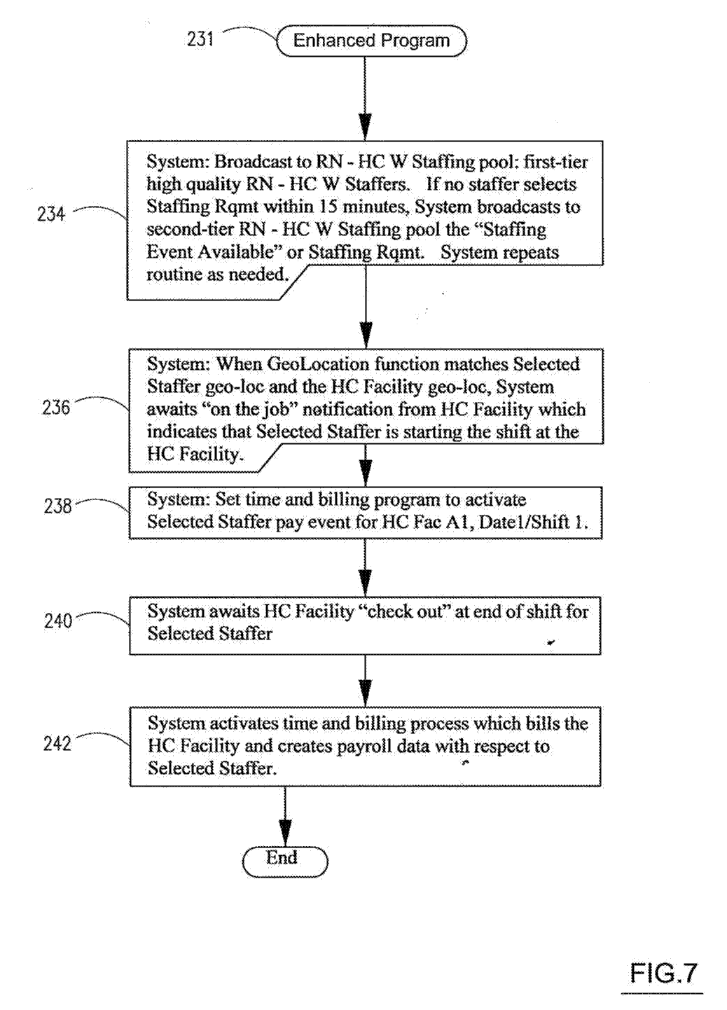

FIG. 7 shows an enhanced module for the scheduler program 231. In step 234, the system broadcasts a “first tier” shift employment call to certain highly qualified healthcare workers in the staffing pool. If no highly rated staffer selects the staffing requirement call within a predetermined time (15 minutes), the scheduler system broadcasts to a second-tier group of healthcare workers the “staffing event available” or the staffing requirement. The scheduler system repeats this cascading call for staffing until the staffing position is filled. In step 236, the scheduler system makes a note when the geolocation of the worker's cell phone matches the geolocation of the healthcare facility. The scheduler system then waits a period of time and a data event indicating that the worker is “on-the-job”. This data event is indicated by a data transfer from the healthcare facility to the scheduler system. See the HC-Fac portal in FIG. 2. In particular, the medical unit computer accepts an input when the temporary worker checks in at the beginning of his or her shift. This check in data is sent to the scheduler system for quality control and to show that the worked is on time.

In step 238, the scheduler system processes a time and billing program to activate a pay event to pay the selected staffer for a certain shift at a healthcare facility. This pay event lists the date and shift and facility. In step 240, the system awaits the healthcare facility data transfer when the temporary staffer checks out or ends the shift\. In step 242, the scheduler system activates a further time and billing process which bills the healthcare facility and creates payroll data with respect to the staffer who worked the shift as well as orders payment to the staffer. Function: time worked times hourly rate.

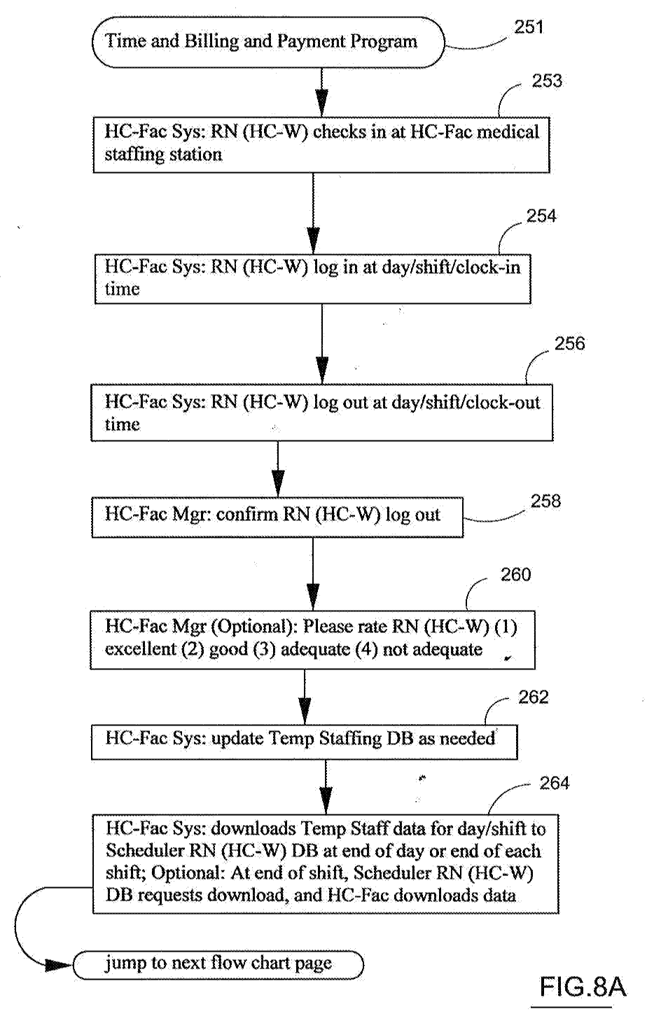

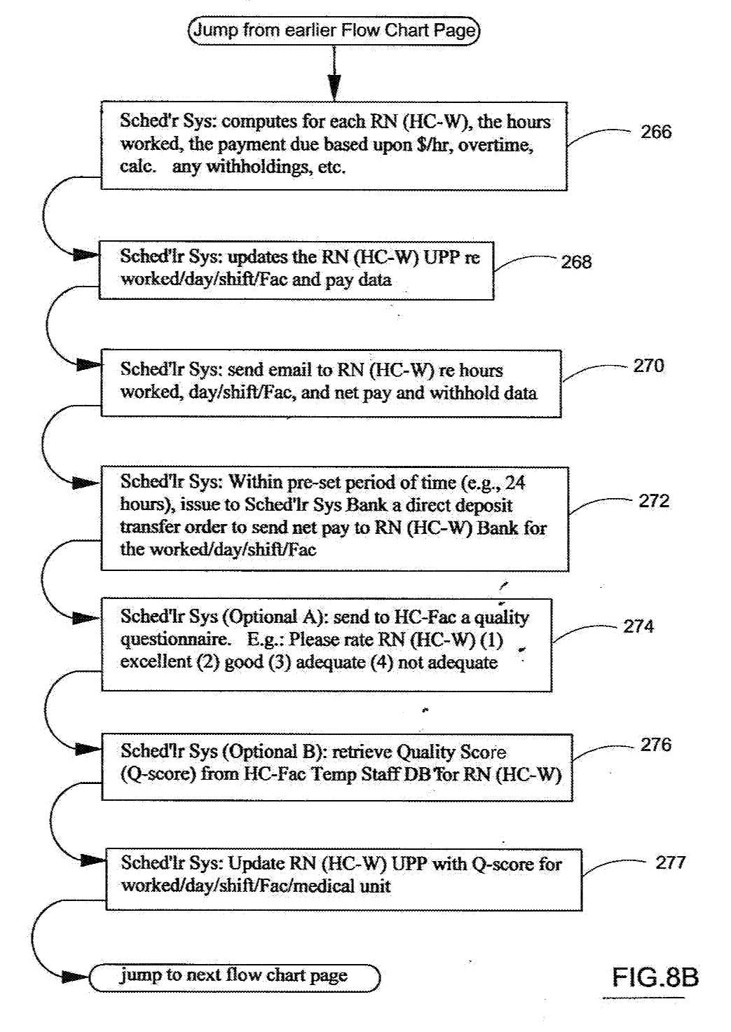

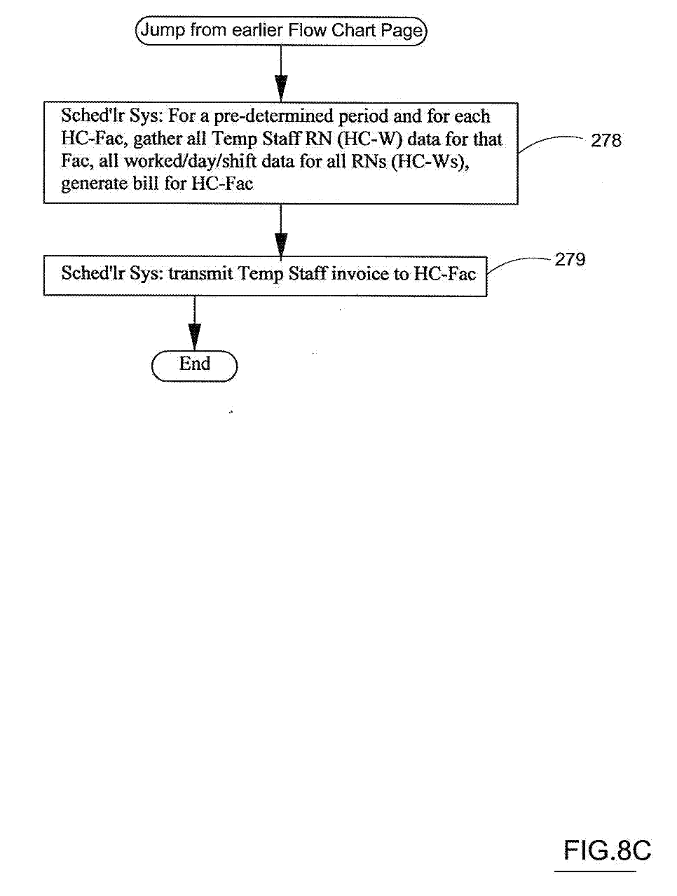

FIGS. 8A, 8B and 8C show a time, billing and payment program 251. In step 253, at the facility system, the healthcare worker checks in at the medical unit and at the beginning of the shift. In step 254, at the facility system, the healthcare worker logs in for that shift. The HC-Fac med unit manager may confirm HC-W on site. In step 256, the healthcare worker logs out at the end of the shift. In step 258, the manager confirms the login and logout for that worker. A note is made in the HC-Fac system. In step 260, as an optional step, the manager rates the quality of service (Q-score) for that healthcare worker as either excellent, good, adequate or not adequate. In step 262, the facility system updates the temporary staffing database at the scheduler system as needed. In step 264, the healthcare system downloads the temporary staff data for that shift to the scheduler healthcare database. This download may occur at the end of the day or at the end of each shift. Optionally, at the end of each shift, the scheduler database may request a download (a download command) and the healthcare facility will then download the temp employment data based upon that command from the scheduler processor.

In step 266, the scheduler system computes, for each healthcare worker, the hours worked, the payment due based on an hourly rate, any overtime pay and any withholdings relative to a payment to the nurse or healthcare worker. In step 268, the scheduling system updates the worker's UPP for that particular shift. In step 270, the scheduler system sends an email to the healthcare worker regarding the hours worked, the shift data, the net pay and any withholdings. In step 272, the scheduler system within a predetermined period of time, such as, within 24 hours, issues a command and a payment order to the scheduler system bank This bank payment order causes a direct deposit to be made to the worker's bank for that shift work. In this manner, the worker is paid within one day or no more than two days after he or she works the shift. This is a further incentive for the healthcare worker to actively engage in the “open shift” broadcast requests sent to the worker's APP because the worker is paid effectively in a 24 hour period after the shift ends.

In step 274, the scheduler system optionally may send a quality questionnaire to the healthcare facility. This is a request to rate the worker as excellent, good, adequate or not adequate. In step 276, as an option, the scheduler system retrieves the quality score from the facility for that particular temporary worker. In step 277, the workers UPP is updated with the quality score or Q score for that particular shift as well as the facility. In step 278, the system, within a predetermined period of time, gathers all the temporary staff employment data for that facility. This includes all days and all shifts for the predetermined period of time. For example, some facilities want weekly invoices and other facilities want biweekly invoices. The scheduler system generates a bill for the facility. In step 278, the scheduler system transmits the temporary staffing invoice to the healthcare facility.

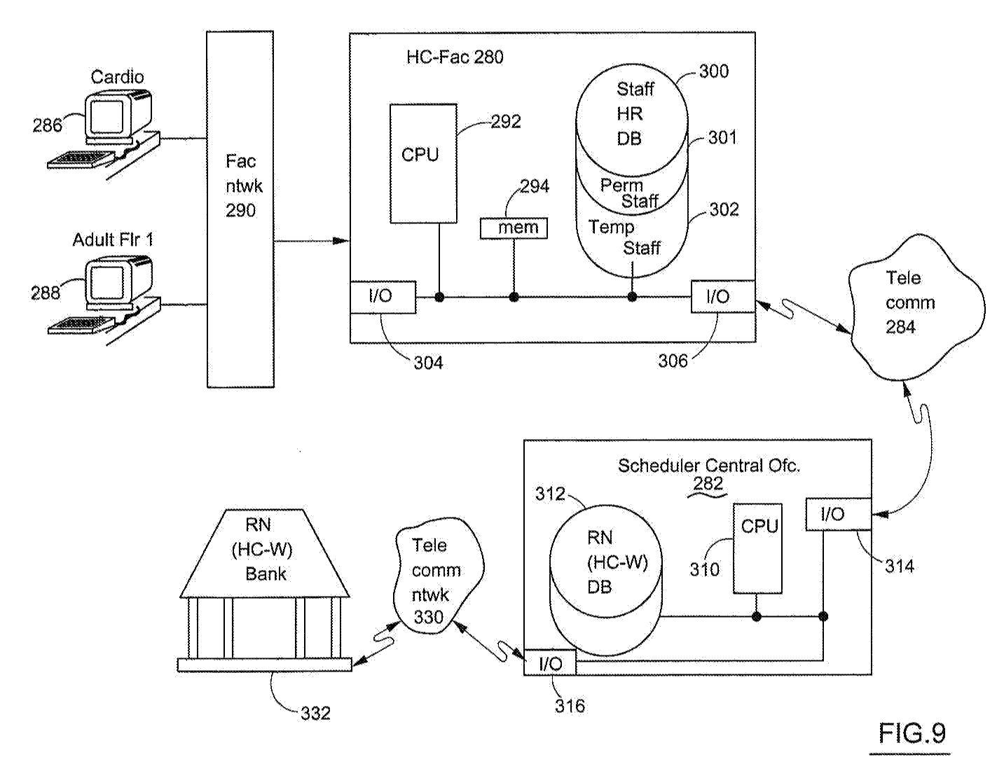

FIG. 9 diagrammatically illustrates the components for the billing system and the general components for the scheduler system and the program integration with the healthcare facility program. The healthcare facility has a computer network 280 with a central processing unit 292. HC Facility 280 communicates via telecommunications network 284 to scheduler central office 282. Returning to Facility system 280, the central processing unit 282 operates in conjunction with memory 294 and staff human resource HR database 300. That database 300 can be generally broken down into permanent staff segment 301 and temporary staff segment 302. The facility computer system 280 also has a facility network 290 which is connected to computers at the various medical units. Cardio medical unit computer 286 and adult floor 1 medical unit computer 288 is connected to the facility network 290. The facility computer 28 obtains data discussed above in connection with the shift check in and shift checkout. Data is handled from the facility network via input output device 304. Transmission via telecommunications network 284 is handled by input output device 306 in facility computer system 280.

The central computer or scheduler computer system 282 includes a central processing unit 310 and a healthcare worker database 312. Also a memory is used in system 282. The telecommunications network 284 is connected to the input output unit 314 of the scheduler computer system 282. In order for payment to be made to the healthcare workers, the scheduler computer system 282 activates input output device 316 and uses telecommunications network 330 to send an “issue payment check” command to the bank 332. Bank 332 is the direct deposit facility for the healthcare worker.

To summarize, the computer-based method for staffing and scheduling a plurality of healthcare workers to fulfill healthcare staffing needs at a plurality of healthcare facilities includes providing a plurality of healthcare workers, FIG. 1, RN 1, 2, 3, each worker having a unique communications device consisting of one of a mobile Internet-enabled device, a cell phone or a tablet and each communications device providing unique GPS geolocation data for that worker. Each healthcare facility has an Internet-connected computer system. FIG. 1, HC-Fac 1, 2, 3, FIG. 2, network 52. A scheduler database, FIG. 2, DB 12, is operable with a scheduler computer system which computer is also Internet-connected. The healthcare worker communications devices, the scheduler computer system and the facility computer system independently communicating with each other. See FIG. 1, 2. The worker profile data (see UPP Tables) includes HC-W identifier data, medical qualification data, and worker availability data as a worker calendar of available shift dates and times. FIG. 1, DB 12, step 86. Healthcare staffing requests are gathered, step 92, from a corresponding healthcare facility for one or more needed workers. The staffing requests include the number of needed workers, worker qualifications and facility shift date and time. FIG. 1, DB 14.

The scheduler database stores the worker UPP profile data, worker calendar and the healthcare staffing requests. FIG. 1, DB 12, 14. The method identifies a plurality of healthcare workers from the super plurality of healthcare workers who match both the staffing requests and the facility shift date and time using the scheduler database. FIG. 1, processor 16. Healthcare workers are notified via the communications device of a match between the respective worker calendar and the corresponding staffing request, and including the corresponding healthcare facility data and shift date and time. See FIG. 1, broadcaster 44 and DB 12, 14.

Within a predetermined response time (step 107), the scheduler accepts responses from the healthcare workers via the communications devices for the corresponding staffing request. The scheduler prioritizes worker acceptance responses for the corresponding staffing request based upon one or more of worker quality of service factors, transit factors, and previous work histories at the corresponding healthcare facility, the quality of service factors and previous work histories stored in the scheduler database as worker profile data. See UPP Tables and steps 110 and 234. The scheduler then selects a sub-plurality of healthcare workers (step 112) for the corresponding staffing request which matches needed workers at the corresponding healthcare facility as selected healthcare workers assigned to a selected shift at the corresponding healthcare facility. The selected workers are notified of the match and selected shift via the worker communications device thereby filling the staffing request with a scheduled healthcare worker for the shift. See Step 112, and the HC-W calendar, DB 12, FIG. 5, function blocks 170, 172, 176.

Within a predetermined antecedent time before each selected shift, the scheduler processor gathers GPS geolocation data from the scheduled worker's communications device. Step 114. The processor and system monitors either a transit time or a transit distance from the current geolocation of the scheduled worker to the corresponding healthcare facility for the selected shift. Step 116. In the event either the transit time or the transit distance exceeds a dynamic predetermined time or distance factor (see Dynamic Table), the scheduler generates an alert to both the scheduled healthcare worker and a shift manager (step 116, 118), the alert to the scheduled healthcare worker delivered via the scheduled worker communications device (FIG. 5) and delivered to the shift manager (step 214, 216, 218) and stores data in the scheduler database as a flag for the upcoming selected shift.

In such event, the healthcare facility sends, for the upcoming selected shift, either a cancel worker command, a hold open worker command or a replace worker command for the upcoming selected shift. FIG. 4C. In the event of the replace command, the scheduler system repeats the identifying step, the matching worker step, the notifying the worker step, the accepting responses from worker step, the step of prioritizing, the selecting step and the notifying selected healthcare worker step for the upcoming selected shift. See steps 220, 223.

In an enhanced embodiment, the method for staffing and scheduling a plurality of healthcare workers to fulfill healthcare staffing needs includes notifying non-selected healthcare workers via the worker communications device for a particular shift. The worker profile data includes a work calendar (see Table 2) which permits the worker to block OFF dates and shift times when the worker is not available for shift work. Also, the method includes blocking the identification of non-available healthcare workers who match both the healthcare staffing requests and the facility shift date and time using the scheduler database. Another enhancement includes monitoring workers who do not respond to notifications as the selected healthcare worker and annotating the worker profile in the scheduler database of such non-response. See Priority Staffing Table and Quality Score Table. Therefore, the healthcare workers are ranked by the scheduler system based upon responses and non-responses to the “job alert” notifications as a selected healthcare worker. These non-responses are ranked lower than the responses. A typical response time is less than 15 minutes.

As for time and billing functions, the system gathers, from the healthcare facility, clock-in and clock-out data for the scheduled healthcare worker for the selected shift. See FIGS. 8A, 8B, and 8C. The system calculates the scheduled healthcare worker's pay for the selected shift at the healthcare facility. Then the system issues a pay order to the worker's bank enabling a deposit of the healthcare worker's pay into the worker's bank See FIG. 9. Typically, the pay order is issued not less than 48 hours after the selected shift ends. The system also calculates invoice data representing a service charge for the healthcare facility for the scheduled healthcare worker's attendance at the selected shift and presents the invoice data to the corresponding healthcare facility.

In the drawings and sometimes in the specification, reference is made to certain abbreviations. The following Abbreviations Table provides a correspondence between the abbreviations and the item or feature.

Abbreviations Table

| | |
|---|---|
| ACK | an acknowledgment sent between two computer devices |
| Admin | Administrator |
| addr | address - including a residential or business address |
| | and may include an IP address for cell phone or tablet |
| | or an Internet Enabled Device (IED) |
| Adlt | adult floor in a HC-Fac |
| alt | alternate or optional path or step, see also “opt” |
| API | application program interface |
| App | application or thin client computer program on an EID |
| Applt-A | a HC-W (healthcare worker) who has a UPP and is |
| | available for healthcare position |
| ASP | application service provider - server on a network |
| AV | audio visual |
| Avail | HC Worker available for work |
| bd | board |
| CD-RW | compact disk drive with read/write feature for CD disk |
| comm | communications, typically telecommunications, |
| | see telecomm |
| comp | computer having internet enabled communications module |
| CPU | central processing unit |
| date1 | a date and shift time or identifier |
| DB | data base |
| Displ | display, typically display a web page or display certain |
| | information |
| doc | document |
| DQ | disqualified for certain HC Assignment |
| drv | drive, e.g., computer hard drive |
| Dr. | doctor |
| DS | data storage |
| e | encryption |
| e.g. | for example |
| em | email |
| equip | equipment |
| emp'ee | employee |
| emp'r | employer or potential employer |
| Fac | Facility, as in Healthcare Facility, see HC-Fac |
| Fnc | function, as in a function to log in data into RN UPP |
| geo | geographic location or code (geo.loc. is GPS data) |
| geo-loc | geographic location data |
| Gen Adlt | General Adult floor in an HC-Fac |
| GPS | geo positioning system and location and time data |
| HC | healthcare |
| HC-Assign | healthcare assignment or task or staffing position |
| HC-Fac | Healthcare Facility, hospital, clinic, surgical center |
| HC field | a category or recognized field for healthcare workers, |
| | including techs and RNs |
| HC-W | healthcare worker, such as RNs, nurse practitioners, |
| | certified healthcare workers, medical technicians, etc. |
| h-link | hyper link to a certain webpage or landing page |
| Hosp | hospital or any other type of healthcare employer such as a |
| | clinic, doctor's offer, nurse registry |
| HR | human resources department or manager |
| h-link | hyper link to a web page |
| I/O | input/output |
| id | identify |
| IE | Internet-enabled, such as an IE device, like a smart phone, |
| | tablet computer, computer, etc. |
| IED | Internet-enabled device, like a smart phone,tablet |
| | computer, computer, etc. |
| IP addr. | internet protocol address of internet enabled device |
| IVR | interactive voice response system or module, an IVR |
| kypd | keypad or touch screen display acting as a keypad |
| kyBd | keyboard or a touch screen display function |
| loc | location |
| loc. ptr. | displayed location on a displayed map |
| mbr | member |
| mem | memory |
| mess | message as in SMS or text message |
| Mgr | Manager |
| mic | microphone or audio pickup device |
| mod | module, unit or sub-system |
| N/A | not available for HC-Fac Shift |
| ntwk | network, namely a telecomm network, typically internet |
| | based network. A local area network is also possible. |
| obj | object, for example, a data object |
| Ofc. | Office |
| opt | optional or alternative program or module |
| perm | permanent, as is a permanent staff in an HC-Fac |
| pgm | program |
| ph | phone, namely an internet enabled phone, such as a |
| | smart phone |
| proc | processor, typically a microprocessor |
| pt. | point or pointer |
| Pty | party engaged in telecomm or internet enabled |
| | communications |
| P/W | password |
| Q-score | quality score based upon reviews from HC-Fac shift reports |
| rcd | database record or record profile |
| rcd-log | a logged entry into a database record |
| re | regarding or relating to |
| reg'd | registered as in Reg'd HC-W, Registered Healthcare |
| | Worker |
| rel | release |
| rem | reminder, such a a reminder email to the HC-W |
| RQT | request |
| rev | review |
| Rpt | Report |
| rt | real time, may include day and time stamp data |
| RX | medical drugs or medical equipment |
| sch | search |
| Sched | a date/shift/time schedule |
| Schd'r | Scheduler as in Scheduler Database |
| sel | select |
| sft | shift as in HC-Worker available Shift at HC-Fac |
| sig cond | signal conditioner |
| smart ph | smart phone coupled to the internet |
| sms | text message |
| spkr | speaker or audio announcement device |
| stmt | statement, as in bank statement, or payment made statement |
| Svr | sever, as in web server |
| sys | system |
| Sys Op | System Operator |
| t | time |
| telecomm | telecommunications system or network |
| tbl | tablet computer |
| txr | transmitter - receiver device, maybe BLUETOOTH (tm), |
| | lan, wireless telecom network, or radio frequency |
| UPP | user's personal profile, for example an HC worker |
| | completes a UPP prior to his or her eligibility for |
| | the match processor |
| URL | Uniform Resource Locator, x pointer, or other network |
| | locator |
| w/ | with |
| w/in | within |
| w/out | without |
| wrt | with respect to |

### Description of Typical System Features

The system described above notes that the user has at least one, and sometimes multiple Internet-enabled IE or IED devices, such as, smart phone, cell phone with an App, tablet computer, computer, or other IE device that is internet enabled. Computer tablets and other electronic devices may be configured in this manner. The App operates in cooperation with or internet portal on a web server and permits the person to access the UPP HC-Worker database and the match processor system. If the user communicates with the system in a voice mode, the user interacts primarily with an interactive voice response system or module, an IVR.

The present invention relates processes data via computer systems, over the Internet and/or on a computer network (LAN or WAN), and computer programs, computer modules and information processing systems accomplish these matching services.

It is important to know that the embodiments illustrated herein and described herein below are only examples of the many advantageous uses of the innovative teachings set forth herein. In general, statements made in the specification of the present application do not necessarily limit any of the various claimed inventions. Moreover, some statements may apply to some inventive features but not to others. In general, unless otherwise indicated, singular elements may be in the plural and vice versa with no loss of generality. In the drawings, like numerals refer to like parts or features throughout the several views.

The present invention could be produced in hardware or software, or in a combination of hardware and software, and these implementations would be known to one of ordinary skill in the art. The system, or method, according to the inventive principles as disclosed in connection with the preferred embodiment, may be produced in a single computer system having separate elements or means for performing the individual functions or steps described or claimed or one or more elements or means combining the performance of any of the functions or steps disclosed or claimed, or may be arranged in a distributed computer system, interconnected by any suitable means as would be known by one of ordinary skill in the art.

According to the inventive principles as disclosed in connection with the preferred embodiments, the invention and the inventive principles are not limited to any particular kind of computer system but may be used with any general purpose computer, as would be known to one of ordinary skill in the art, arranged to perform the functions described and the method steps described. The operations of such a computer, as described above, may be according to a computer program contained on a medium for use in the operation or control of the computer as would be known to one of ordinary skill in the art. The computer medium which may be used to hold or contain the computer program product, may be a fixture of the computer such as an embedded memory or may be on a transportable medium such as a disk, as would be known to one of ordinary skill in the art. Further, the program, or components or modules thereof, may be downloaded from the Internet of otherwise through a computer network.

The invention is not limited to any particular computer program or logic or language, or instruction but maybe practiced with any such suitable program, logic or language, or instructions as would be known to one of ordinary skill in the art. Without limiting the principles of the disclosed invention any such computing system can include, inter alia, at least a computer readable medium allowing a computer to read data, instructions, messages or message packets, and other computer readable information from the computer readable medium. The computer readable medium may include non-volatile memory, such as ROM, flash memory, floppy disk, disk drive memory, CD-ROM, and other permanent storage. Additionally, a computer readable medium may include, for example, volatile storage such as RAM, buffers, cache memory, and network circuits.

Furthermore, the computer readable medium may include computer readable information in a transitory state medium such as a network link and/or a network interface, including a wired network or a wireless network, that allow a computer to read such computer readable information.

Those of skill in the art will appreciate that the various illustrative modules, components, engines, and method steps described in connection with the above described figures and the embodiments disclosed herein can often be implemented as electronic hardware, software, firmware or combinations of the foregoing. To clearly illustrate this interchangeability of hardware and software, various illustrative modules and method steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module or step is for ease of description. Specific functions can be moved from one module or step to another without departing from the invention.

Moreover, the various illustrative modules, components, engines, and method steps described in connection with the embodiments disclosed herein can be implemented or performed with hardware such as a general purpose processor, a digital signal processor (“DSP”), an application specific integrated circuit (“ASIC”), field programmable gate array (“FPGA”) or other programmable logic device, discrete gate or transistor logic, discrete hardware components, or any combination thereof designed to perform the functions described herein. A general-purpose processor is hardware and can be a microprocessor, but in the alternative, the processor can be any hardware processor or controller, microcontroller. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm and the functionality of a component, engine, or module described in connection with the embodiments disclosed herein can be embodied directly in hardware, in software executed by a processor, or in a combination of the two. Software can reside in computer or controller accessible computer-readable storage media including RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent exemplary embodiments of the invention and are therefore representative of the subject matter which is broadly contemplated by the present invention. It is further understood that the scope of the present invention fully encompasses other embodiments and that the scope of the present invention is accordingly limited by nothing other than the appended claims.

1. A computer-based method for staffing and scheduling a plurality of healthcare workers to fulfill healthcare staffing needs at a plurality of healthcare facilities comprising:
providing a super plurality of healthcare workers, each worker having a unique communications device consisting of one of a mobile Internet-enabled device, a cell phone or a tablet and each communications device providing unique GPS geolocation data;
providing one or more healthcare facilities each having a facility Internet-connected computer system;
providing a scheduler database operable with a scheduler computer system which is Internet-connected;
said healthcare worker communications devices, said scheduler computer system and the facility computer system independently communicating with each other;
gathering worker profile data which includes identifier data, qualification data, and worker availability data as a worker calendar of available shift dates and times;
gathering healthcare staffing requests from a corresponding healthcare facility for one or more needed workers, said staffing requests including the number of needed workers, worker qualifications and facility shift date and time;
storing, in said scheduler database, said worker profile data, worker calendar and said healthcare staffing requests;
identifying a plurality of healthcare workers from said super plurality of healthcare workers who match both said staffing requests and the facility shift date and time using said scheduler database;
notifying said plurality of healthcare workers via said communications device of a match between the respective worker calendar and the corresponding staffing request, and including the corresponding healthcare facility data and shift date and time;
within a predetermined response time, accepting responses from said plurality of healthcare workers via said communications devices for said corresponding staffing request;
prioritizing worker acceptance responses for said corresponding staffing request based upon one or more of worker quality of service factors, transit factors, and previous work histories at the corresponding healthcare facility, said quality of service factors and previous work histories stored in said scheduler database as worker profile data;
selecting a sub-plurality of healthcare workers for said corresponding staffing request which matches needed workers at said corresponding healthcare facility as selected healthcare workers assigned to a selected shift at said corresponding healthcare facility;
notifying said selected workers of said match and selected shift via said worker communications device thereby filling said staffing request with a scheduled healthcare worker for said shift;
within a predetermined antecedent time before each selected shift, gathering GPS geolocation data from said scheduled worker's communications device;
monitoring either a transit time or a transit distance from the current geolocation of said scheduled worker to said corresponding healthcare facility for said selected shift;
in the event either said transit time or said transit distance exceeds a dynamic predetermined time or distance factor, generating an alert to both said scheduled healthcare worker and a shift manager, said alert to said scheduled healthcare worker delivered via said scheduled worker communications device and delivered to said shift manager and stored in said scheduler database as a flag for said upcoming selected shift;
receiving from said corresponding healthcare facility for said upcoming selected shift either a cancel worker command, a hold open worker command or a replace worker command for said upcoming selected shift; and
in the event of said replace command, repeating the identifying and matching further workers, notifying said further workers, accepting responses from said further workers, prioritizing, selecting and notifying further selected healthcare workers for said upcoming selected shift.

2. A method for staffing and scheduling a plurality of healthcare workers to fulfill healthcare staffing needs as claimed in claim 1 including notifying non-selected ones of said plurality of healthcare workers via said worker communications device.

3. A method for staffing and scheduling a plurality of healthcare workers to fulfill healthcare staffing needs as claimed in claim 2 wherein said worker profile data includes a work calendar which said worker time blocks OFF dates and shift times when the corresponding worker is not available for shift work and the method includes:
blocking the identification of non-available healthcare workers who match both said healthcare staffing requests and the facility shift date and time using said scheduler database.

4. A method for staffing and scheduling a plurality of healthcare workers to fulfill healthcare staffing needs as claimed in claim 3 including:
from the group of selected healthcare workers who match staffing request at said corresponding healthcare facility, monitoring those who do not respond to the notification as said selected healthcare worker; and
annotating said worker profile in said scheduler database of such non-response.

5. A method for staffing and scheduling a plurality of healthcare workers to fulfill healthcare staffing needs as claimed in claim 4 including ranking said sub-plurality of healthcare workers who match staffing requests based upon responses and non-responses to said notification as said selected healthcare worker, said non-responses being ranked lower than said responses.

6. A method for staffing and scheduling a plurality of healthcare workers to fulfill healthcare staffing needs as claimed in claim 5 wherein said predetermined response time is less than 15 minutes.

7. A method for staffing and scheduling a plurality of healthcare workers to fulfill healthcare staffing needs as claimed in claim 6 including:
gathering, from said corresponding healthcare facility, clock-in and clock-out data for said scheduled healthcare worker for said selected shift;
calculating said scheduled healthcare worker's pay for said selected shift at said corresponding healthcare facility;
issuing a pay order to said worker bank enabling a deposit of said healthcare worker's pay into said worker bank;
the issuing of said pay order occurring not less than 48 hours after said selected shift ends.

8. A method for staffing and scheduling a plurality of healthcare workers to fulfill healthcare staffing needs as claimed in claim 7 including:
further calculating invoice data representing a service charge to said corresponding healthcare facility for said scheduled healthcare worker's attendance at said selected shift; and
presenting said invoice data to said corresponding healthcare facility.

9. A computer-based method for staffing and scheduling a plurality of healthcare workers to fulfill healthcare staffing needs at a plurality of healthcare facilities comprising:
providing a super plurality of healthcare workers, each worker having a unique communications device, said worker communications device consisting of a mobile Internet-enabled device, cell phone or tablet, each worker communications device providing unique GPS location data upon a GPS tracking command;
providing a super plurality of healthcare facilities, each facility having a facility Internet-connected computer system;
providing a scheduler database operable with a scheduler computer system which is Internet-connected;
using one or more telecommunications networks to independently communicate with said healthcare worker communications devices, said scheduler computer system and said facility computer systems;
from said super plurality of healthcare workers, gathering from each worker a unique worker profile data which includes personal identifying data, medical qualification data, worker bank deposit data, and worker availability data, said worker availability data including at least a work week calendar of available shift dates and times;
from a plurality of healthcare facilities of said super plurality of healthcare facilities, gathering healthcare staffing requests for a plurality of needed workers, said staffing requests including the number of needed workers, medical qualifications for each needed worker, and facility shift date and time for each needed worker;
storing, in said scheduler database, said worker profile data, worker calendar and said healthcare staffing requests;
identifying a plurality of healthcare workers from said super plurality of healthcare workers who match both said healthcare staffing requests and the facility shift date and time using said scheduler database;
audibly or visually notifying said plurality of healthcare workers via said telecommunications networks and said worker communications device of a match between the respective worker work week calendar and said corresponding staffing request, the worker notification including the corresponding healthcare facility data, scope of work and shift date and time;
within a predetermined response time, accepting responses from said plurality of healthcare workers via said telecommunications networks of said corresponding staffing request at the corresponding healthcare facility;
prioritizing the worker acceptance responses for said corresponding staffing request at the corresponding healthcare facility based upon one or more of worker quality of service factors, transit to facility distances and previous work histories at the corresponding healthcare facility, said quality of service factors and previous work histories stored in said scheduler database as worker profile data;
selecting a sub-plurality of healthcare workers for said corresponding staffing request at the corresponding healthcare facility, said sub-plurality of healthcare workers matching a number of needed workers at said corresponding healthcare facility as selected healthcare workers assigned to a selected shift at said corresponding healthcare facility;
notifying said selected healthcare workers of said match and selected shift via said worker communications device thereby filling said staffing request with a scheduled healthcare worker;
within a predetermined antecedent time before each selected shift, notifying each selected healthcare worker of the upcoming selected shift;
within a further predetermined antecedent time before each selected shift, gathering GPS location data from scheduled healthcare worker for said upcoming selected shift;
monitoring either or both of a transit time and a transit distance from the current geolocation of said scheduled healthcare worker to said corresponding healthcare facility for said selected shift;
in the event either said transit time or said transit distance exceeds a dynamic predetermined time or distance factor, generating an alert to both said scheduled healthcare worker and a shift manager, said alert to said scheduled healthcare worker delivered via said scheduled worker communications device and delivered to said shift manager and stored in said scheduler database as a flag for said upcoming selected shift;
receiving from said corresponding healthcare facility for said upcoming selected shift either a cancel scheduled worker command, a hold open scheduled worker command or a replace scheduled worker command for said upcoming selected shift; and
in the event of said replace command, repeating the identifying and matching further workers, audibly or visually notifying said further workers, accepting responses from said further workers, prioritizing, selecting and notifying further selected healthcare workers for said upcoming selected shift.

10. A method for staffing and scheduling a plurality of healthcare workers to fulfill healthcare staffing needs as claimed in claim 9 including notifying non-selected ones of said plurality of healthcare workers via said worker communications device.

11. A method for staffing and scheduling a plurality of healthcare workers to fulfill healthcare staffing needs as claimed in claim 10 wherein said unique worker profile data includes a personal work calendar which said worker time blocks OFF dates and shift times when the corresponding worker is not available for shift work and the method includes:
blocking the identification of non-available healthcare workers who match both said healthcare staffing requests and the facility shift date and time using said scheduler database.

12. A method for staffing and scheduling a plurality of healthcare workers to fulfill healthcare staffing needs as claimed in claim 9 wherein said unique worker profile data includes a personal work calendar which said worker time blocks OFF dates and shift times when the corresponding worker is not available for shift work and the method includes:
blocking the identification of non-available healthcare workers who match both said healthcare staffing requests and the facility shift date and time using said scheduler database.

13. A method for staffing and scheduling a plurality of healthcare workers to fulfill healthcare staffing needs as claimed in claim 12 including:
from the group of selected healthcare workers who match a staffing request at said corresponding healthcare facility, monitoring those who do not respond to the notification as said selected healthcare worker; and
annotating said unique worker profile in said scheduler database of such non-response.

14. A method for staffing and scheduling a plurality of healthcare workers to fulfill healthcare staffing needs as claimed in claim 13 including ranking said sub-plurality of healthcare workers who match staffing request based upon responses and non-responses to said notification as said selected healthcare worker, said non-responses being ranked lower than said responses.

15. A method for staffing and scheduling a plurality of healthcare workers to fulfill healthcare staffing needs as claimed in claim 14 wherein said predetermined response time is less than 15 minutes.

16. A method for staffing and scheduling a plurality of healthcare workers to fulfill healthcare staffing needs as claimed in claim 15 including:
gathering, from said corresponding healthcare facility, clock-in and clock-out data for said scheduled healthcare worker for said selected shift;
calculating said scheduled healthcare worker's pay for said selected shift at said corresponding healthcare facility;
issuing a pay order to said worker bank enabling a deposit of said healthcare worker's pay into said worker bank;
the issuing of said pay order occurring not less than 48 hours after said selected shift ends.

17. A method for staffing and scheduling a plurality of healthcare workers to fulfill healthcare staffing needs as claimed in claim 16 including:
further calculating invoice data representing a service charge to said corresponding healthcare facility for said scheduled healthcare worker's attendance at said selected shift; and
presenting said invoice data to said corresponding healthcare facility.
